(19) United States
(12) Patent Application Publication
(10) Pub. No.: US 2005/0144399 A1
(43) Pub. Date: Jun. 30, 2005

(54) Multiprocessor system, and consistency control device and consistency control method in multiprocessor system

(75) Inventor: Takeo Hosomi, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 11/020,008

(22) Filed: Dec. 23, 2004

(30) Foreign Application Priority Data
Dec. 24, 2003 (JP) 427283/2003

(51) Int. Cl. G06F 12/00

(52) U.S. Cl. 711/145; 711/147

(57) ABSTRACT

A multiprocessor system with cells having a plurality of CPUs sharing a memory and a consistency control device connected through a network, in which the consistency control device includes a request unit which issues an access request and a speculative access request, a home unit which receives an access request from the request unit of each cell, and an owner unit which receives a speculative access request from the request unit of each cell, the request unit further including an owner decision unit which predicts a cell holding requested data and a determination unit which determines whether processing based on prediction is to be conducted or not.

### BACKGROUND OF THE INVENTION

1. Field of the Invention

The present invention relates to a consistency control device and a consistency control method in a tightly coupled multiprocessor system which shares a memory.

2. Description of the Related Art

Technique related to a conventional consistency control method in a tightly-coupled multiprocessor system which shares a memory is disclosed in “James Laudon and Daniel Leonski, The SGI Origin: A ccNUMA Highly Scalable Server, Proceedings of the 24th Annual International Symposium on Computer Architecture, 1997, pp 241-251” (hereinafter referred to as Literature 1). In the following, the conventional technique will be described with reference to the drawings.

Structure of a conventional multiprocessor system to which consistency control is applied is shown in FIG. 1. A plurality of cells 104 including a plurality of CPUs 101, a consistency control device 102 and a shared memory 103 are connected by a network 105. Each CPU 101 has a cache 106 to temporarily hold data of the shared memory 103 in the cache 106, thereby realizing speed-up of data access.

On the other hand, because the caches 106 of the plurality of CPUs 101 access the same data on the shared memory 103 and hold the data in the respective caches 106, the function of maintaining consistency of these copies (consistency control) is required, so that the consistency control device 102 as a unit for this function is provided.

FIG. 18 shows a structure of the consistency control device 102 in charge of the consistency control. The consistency control device 102 is composed of a request unit 107, a home unit 108 and an owner unit 109. Consistency control of data is realized by sending and receiving a request and an acknowledgement message to/from the request unit 107, the home unit 108 and the owner unit 109 of the consistency control devices 102 in the plurality of cells 104.

FIGS. 19 and 20 and FIGS. 21 and 22 show a flow of a message among the request unit 107, the home unit 108 and the owner unit 109 in a case where the consistency control device 102 receives an access request which is issued by the CPU 101 when the CPU accesses data not existing in the cache 106.

In the following, description will be made, as an example, of a case where when in a cell 104-a, the CPU 101 accesses data not existing in the cache 106, an access request is issued from the consistency control device 102 of the cell 104-a to the consistency control device 102 of a cell 104-b.

FIGS. 19 and 21 show operation executed when there exists latest data in the shared memory 103 of the cell 104-b to which an access request is made. In this case, the request unit 107 of the consistency control device 102 in the cell 104-a first issues an access request to the home unit 108 of the consistency control device 102 in the cell 104-b. The home unit 108 of the cell 104-b reads data from the shared memory 103 in response to the access request from the request unit 107 of the cell 104-a through the network 105 to give an access acknowledgement to the request unit 107 of the requesting source cell 104-a.

FIGS. 20 and 22 show operation executed in a case where latest data exists in the cache 106 in a cell 104-c when the consistency control device 102 of the cell 104-a makes an access request to the consistency control device 102 of the cell 104-b. The request unit 107 of the consistency control device 102 in the cell 104-a issues an access request to the home unit 108 of the consistency control device 102 in the cell 104-b. Upon receiving the access request through the network 105, the home unit 108 of the cell 104-b issues a consistency request to the owner unit 109 of the cell 104-c including the CPU 101 which holds a copy of latest data in the cache 106.

Upon receiving the consistency request through the network 105, the owner unit 109 of the cell 104-c reads the data from the cache 106 of the relevant CPU 101 to give an access acknowledgement to the request unit 107 of the cell 104-a and a consistency acknowledgement to the home unit 108 of the cell 104-b.

Such a case as shown in FIGS. 20 and 22 is in general referred to as a case of cache-to-cache transfer because data is transferred from the cache 106 holding latest data to the cache 106 of the CPU 101 which has issued a request.

Conventional art for improving performance in this case of cache-to-cache transfer is disclosed, for example, in Manuel E. Acacio, Jose Gonzalez, Jose M. Garcia and Jose Duato, Owner Prediction for Accelerating Cache-to-Cache Transfer Misses in a cc-NUMA Architecture, Proceedings of SC2002 (hereinafter referred to as Literature 2). In the following, the conventional art will be described with reference to the drawings.

FIG. 23 shows a structure of the request unit 107. The request unit 107 includes an owner decision unit 110 and a determination unit 111.

With an access request from the CPU 101 as an input, the owner decision unit 110 predicts which cell 104 holds the latest data and outputs it.

With an access request from the CPU 101 as an input, the determination unit 111 determines whether processing based on the prediction should be conducted or not and outputs the determination result.

When the determination unit 111 does not instruct on operation based on prediction, execute the same operation as that in the conventional art shown in FIGS. 19, 20, 21 and 22.

When the determination unit 111 instructs on operation based on prediction, execute the operation shown in FIGS. 24 and 25.

Here, description will be made assuming that the CPU 101 of the cell 104-a accesses data not existing in the cache 106 and the data is placed in the shared memory 103 of the cell 104-c and a speculative access request is made to the predicted cell 104-b.

FIG. 24 shows operation conducted when the predicted cell 104-b holds data. The request unit 107 of the cell 104-a issues a speculative access request to the owner unit 109 of the cell 104-b predicated by the owner decision unit 110. Upon receiving the speculative access request, the owner unit 109 reads data from the cache 106 to give an access acknowledgment to the request unit 107 of the cell 104-a and a consistency acknowledgement to the home unit 108.

On the other hand, FIG. 25 shows operation conducted when the predicted cell 104-b does not hold the data. The request unit 107 of the cell 104-a issues a speculative access request to the owner unit 109 of the cell 104-b predicated by the owner decision unit 110.

While the owner unit 109 of the cell 104-b receives the speculative access request, because of not holding the data, it issues a speculation failure acknowledgement to the home unit 108 of the cell 104-b. In response to the speculation failure acknowledgement, the home unit 108 of the cell 104-c issues a consistency request to the owner unit 109 of a cell (e.g. cell 104-d) holding the data. The owner unit 109 of the cell (cell 104-d) having received the consistency request reads the data from the cache 106 to give an access acknowledgement to the request unit 107 of the requesting source cell 104-a and a consistency acknowledgement to the home unit 108 of the cell 104-c.

Structures of conventional determination unit 111 and owner decision unit 110 are shown in FIGS. 26 and 27.

The determination unit 111, which holds a determination information table 114 with a program counter (PC) 113 as a key, searches the determination information table 114 based on a value of the PC 113 as of when the CPU 101 issues an access request and receives the searched contents at a determination circuit 115 to determine whether operation based on prediction should be conducted or not.

The owner decision unit 110 includes a predicted cell information table 118 that uses a key as an index, which key is generated at a key generation circuit 117 from the PC 113 and an address 116 of an access request. A request issuing circuit 119 issues a speculative access request to the owner unit 109 of a predicted cell.

The above-described conventional art has the following problems.

First problem is that sufficient memory access performance can not be obtained at the time of a cache miss.

The reason is that with the technique disclosed in the above-described Literature 1, a memory access latency at the time of cache-to-cache transfer is long. On the other hand, with the technique disclosed in the above-described Literature 2, a memory access latency at the time of cache-to-cache transfer is improved by prediction to have better performance when the prediction is fulfilled, while when the prediction is not fulfilled, the latency is further degraded than that by the technique disclosed in Literature 1, resulting in failing to improve performance as a whole.

Second problem is that the technique disclosed in Literature 2 requires a large amount of hardware for a determination unit and an owner decision unit.

The reason is as follows. In the determination information table 114 and the predicted cell information table 118, history information of an access made before using the PC 113 and the address 116 (a plurality of pairs having the same key in practice) is held. In order to make the history information accurate, as to the determination information table 114, it is necessary to prevent as much as possible, among access requests output by the CPU 101, those having different values of the PC 113 from using the same entry of the determination information table 114. Also as to the predicted cell information table 118, it is necessary to prevent as much as possible, among access requests output by the CPU 101, those having different values of the PC 113 and the address 116 from using the same entry of the predicted cell information table 118. Therefore, with the technique disclosed in Literature 2, the former table is formed of memory of 2 K entries and the latter is formed of memory of 16 K entries.

### SUMMARY OF THE INVENTION

First object of the present invention is to provide a multiprocessor system, and a consistency control device and a consistency control method in a multiprocessor system which enable improvement in memory access performance in a case where cache-to-cache transfer is conducted.

Second object of the present invention is to provide a multiprocessor system, and a consistency control device and a consistency control method in a multiprocessor system which enable the amount of hardware necessary for consistency control to be reduced.

According to the first aspect of the invention, a multiprocessor system with cells having a plurality of CPUs sharing a memory connected through a network, comprises a request consistency control device configured to generate both an access request and a speculative access request simultaneously, a home consistency control device configured to receive the access request, and an owner consistency control device configured to receive the speculative access request, wherein the request consistency control device includes an owner decision unit which predicts which cell holding requested data, and a determination unit which determines whether processing based on prediction is to be conducted or not.

In the preferred construction, the owner consistency control device has a function of issuing a speculative access acknowledgement in response to a speculative access request, and the request consistency control device has a function of receiving a speculative access acknowledgement.

In another preferred construction, the home consistency control device has a function of issuing a consistency request in response to an access request, and the owner consistency control device has a function of receiving a consistency request.

In another preferred construction, the home consistency control device has a function of issuing a temporary acknowledgement in response to an access request, and the request consistency control device further has a function of receiving a temporary acknowledgement from the home unit of each cell.

In another preferred construction, the owner consistency control device further has a function of issuing a speculation consistency acknowledgement in response to a speculative access request, and the home consistency control device further has a function of receiving a speculation consistency acknowledgement.

In another preferred construction, the owner consistency control device further has a function of issuing a speculation consistency acknowledgement in response to a speculative access request, the home consistency control device further has a function of receiving a speculation consistency acknowledgement and when the home consistency control device is yet to receive a relevant access request at a time point when receiving the speculation consistency acknowledgement, issuing a speculative access acknowledgement invalidation request, and the request consistency control device further has a function of receiving a speculative access acknowledgement invalidation request.

In another preferred construction, the owner consistency control device further has a function of issuing a speculative access acknowledgement and a speculation consistency acknowledgement in response to a speculative access request, the home consistency control device further has a function of receiving a speculation consistency acknowledgement and a function of, when the home consistency control device is yet to receive a relevant access request at a time point when receiving the speculation consistency acknowledgement, issuing a speculative access acknowledgement invalidation request, and the request consistency control device further has a function of receiving a speculative access acknowledgement, and a function of receiving a speculative access acknowledgement invalidation request and a function of invalidating a relevant speculative access acknowledgement in response to a speculative access acknowledgement invalidation request.

In another preferred construction, the home consistency control device has a function of issuing a consistency request in response to an access request, the owner consistency control device has a function of receiving a consistency request, and the request consistency control device further includes a request filter table, the consistency control device registering an address of a request received lately by the owner unit and not existing in a cache at the request filter table and when the owner unit receives a request, if there exists in the request filter table an entry coinciding with the request, processing a request message without making an inquiry to the CPU.

In another preferred construction, the determination unit includes a table with a CPU number in a cell as a key, the determination unit determining whether prediction operation is to be conducted according to a value of a CPU number stored in the table.

In another preferred construction, the determination unit includes a determination value generation circuit which generates a value indicative of existence/non-existence of prediction operation by random numbers or with fixed regularities, the determination unit determining whether prediction operation is to be conducted according to a value output by the determination value generation circuit.

In another preferred construction, the owner decision unit includes a table with a CPU number in a cell as a key, the owner decision unit deciding to which cell a speculative access request is to be issued according to a value of a CPU number stored in the table.

In another preferred construction, the owner decision unit includes a cell number generation circuit which generates a value indicative of a number of a cell by random numbers or with fixed regularities, the owner decision unit deciding to which cell a speculative access request is to be issued according to a value output by the cell number generation circuit.

In another preferred construction, the owner decision unit includes a cell number generation circuit which generates a value indicative of a number of a cell by random numbers or with fixed regularities, the owner decision unit deciding to which cell a speculative access request is to be issued according to a value output by the cell number generation circuit, and the network has at least one channel, the channel having a structure which ensures, with respect to messages flowing through the channel, only an order of arrival of messages whose pairs of a transmission source cell and a transmission destination cell are the same and not an order of arrival of messages whose pairs are different.

According to the second aspect of the invention, a consistency control method in a multiprocessor system with cells having a plurality of CPUs sharing a memory connected through a network, comprises the steps of a request consistency control device generating both an access request and a speculative access request simultaneously, a home consistency control device receiving the access request, and a owner consistency control device receiving the speculative access request, wherein the request consistency control device predicts which cell holding requested data and determines whether processing based on prediction is to be conducted or not.

In the preferred construction, the consistency control method comprises steps of the owner consistency control device issuing a speculative access acknowledgement in response to a speculative access request, and the request consistency control device receiving a speculative access acknowledgement.

In another preferred construction, the consistency control method comprises steps of the home consistency control device issuing a consistency request in response to an access request, and the owner consistency control device receiving a consistency request.

In another preferred construction, the consistency control method comprises steps of the home consistency control device issuing a temporary acknowledgement in response to an access request, and the request consistency control device receiving a temporary acknowledgement.

In another preferred construction, the consistency control method comprises steps of the owner consistency control device issuing a speculation consistency acknowledgement in response to a speculative access request, and the home consistency control device receiving a speculation consistency acknowledgement.

In another preferred construction, the consistency control method comprises steps of the owner consistency control device issuing a speculation consistency acknowledgement in response to a speculative access request, the home consistency control device receiving a speculation consistency acknowledgement and when a relevant access request is yet to be received at a time point when receiving the speculation consistency acknowledgement, and issuing a speculative access acknowledgement invalidation request, and the request consistency control device receiving a speculative access acknowledgement invalidation request.

In another preferred construction, the consistency control method comprises steps of the owner consistency control device issuing a speculative access acknowledgement and a speculation consistency acknowledgement in response to a speculative access request, the home consistency control device receiving a speculation consistency acknowledgement and when a relevant access request is yet to be received at a time point when receiving the speculation consistency acknowledgement, and issuing a speculative access acknowledgement invalidation request, and the request consistency control device receiving a speculative access acknowledgement, and receiving a speculative access acknowledgement invalidation request and a function of invalidating a relevant speculative access acknowledgement in response to a speculative access acknowledgement invalidation request.

In another preferred construction, the consistency control method comprises steps of the home consistency control device issuing a consistency request in response to an access request and receiving a consistency request, and the request consistency control device registering an address of a request received lately and not existing in a cache at a request filter table and when receiving a request, if there exists an entry coinciding with the request in the request filter table, processing a request message without making an inquiry to the CPU.

In another preferred construction, the consistency control method comprises steps of the request consistency control device includes a table with a CPU number in a cell as a key and includes the step of determining whether prediction operation is to be conducted according to a value of a CPU number stored in the table.

In another preferred construction, the consistency control method comprises steps of the request consistency control device generating a value indicative of existence/non-existence of prediction operation by random numbers or with fixed regularities, and determining whether prediction operation is to be conducted according to a generated value.

In another preferred construction, the consistency control method comprises steps of the request consistency control device includes a table with a CPU number in a cell as a key and includes the step of deciding to which cell a speculative access request is to be issued according to a value of a CPU number stored in the table.

In another preferred construction, the consistency control method comprises steps of the request consistency control device generating a value indicative of a number of a cell by random numbers or with fixed regularities, and deciding to which cell a speculative access request is to be issued according to a generated value.

According to further aspect of the invention, a consistency control device in a multiprocessor system with cells having a plurality of CPUs sharing a memory and a consistency control device connected through a network, comprises a request unit which issues an access request and a speculative access request, a home unit which receives an access request, and an owner unit which receives a speculative access request, wherein the request unit includes an owner decision unit which predicts which cell holding requested data, and a determination unit which determines whether processing based on prediction is to be conducted or not.

In the preferred construction, the owner unit issues a speculative access acknowledgement in response to a speculative access request, and the request unit has a function of receiving a speculative access acknowledgement.

In another preferred construction, the home unit has a function of issuing a consistency request in response to an access request, and the owner unit has a function of receiving a consistency request.

In another preferred construction, the home unit further issues a temporary acknowledgement in response to an access request, and the request unit further has a function of receiving a temporary acknowledgement.

In another preferred construction, the owner unit further issues a speculation consistency acknowledgement in response to a speculative access request, and the home unit further has a function of receiving a speculation consistency acknowledgement.

In another preferred construction, the owner unit further has a function of issuing a speculation consistency acknowledgement in response to a speculative access request, the home unit further has a function of receiving a speculation consistency acknowledgement and a function of, when the home unit is yet to receive a relevant access request at a time point when receiving the speculation consistency acknowledgement, issuing a speculative access acknowledgement invalidation request, and the request unit further has a function of receiving a speculative access acknowledgement invalidation request.

In another preferred construction, the owner unit further has a function of issuing a speculative access acknowledgement and a speculation consistency acknowledgement in response to a speculative access request, the home unit further has a function of receiving a speculation consistency acknowledgement and a function of, when the home unit is yet to receive a relevant access request at a time point when receiving the speculation consistency acknowledgement, issuing a speculative access acknowledgement invalidation request, and the request unit further has a function of receiving a speculative access acknowledgement, and a function of receiving a speculative access acknowledgement invalidation request and a function of invalidating a relevant speculative access acknowledgement in response to a speculative access acknowledgement invalidation request.

In another preferred construction, the home unit has a function of issuing a consistency request in response to an access request, the owner unit has a function of receiving a consistency request, and the consistency control device includes a request filter table, the consistency control device registering an address of a request received lately by the owner unit and not existing in a cache at the request filter table and when the owner unit receives a request, if there exists in the request filter table an entry coinciding with the request, processing a request message without making an inquiry to the CPU.

In another preferred construction, the determination unit includes a table with a CPU number in a cell as a key, the determination unit determining whether prediction operation is to be conducted according to a value of a CPU number stored in the table.

In another preferred construction, the determination unit includes a determination value generation circuit which generates a value indicative of existence/non-existence of prediction operation by random numbers or with fixed regularities, the determination unit determining whether prediction operation is to be conducted according to a value output by the determination value generation circuit.

In another preferred construction, the owner decision unit includes a table with a CPU number in a cell as a key, the owner decision unit deciding to which cell a speculative access request is to be issued according to a value of a CPU number stored in the table.

In another preferred construction, the owner decision unit includes a cell number generation circuit which generates a value indicative of a number of a cell by random numbers or with fixed regularities, the owner decision unit deciding to which cell a speculative access request is to be issued according to a value output by the cell number generation circuit.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a diagram showing a structure of a multiprocessor system according to a conventional technique and the present invention;

FIG. 2 is a diagram showing operation of a consistency control device according to a first embodiment of the present invention;

FIG. 3 is a diagram showing operation of the consistency control device according to the first embodiment of the present invention;

FIG. 4 is a diagram showing operation of the consistency control device according to the first embodiment of the present invention;

FIG. 5 is a diagram showing a structure of the consistency control device according to the first embodiment of the present invention;

FIG. 6 is a diagram showing a structure of a determination unit according to the first embodiment of the present invention;

FIG. 7 is a diagram showing a structure of an owner decision unit according to the first embodiment of the present invention;

FIG. 8 is a diagram showing operation of a request filter table according to the first embodiment of the present invention;

FIG. 9 is a diagram showing operation of the request filter table according to the first embodiment of the present invention;

FIG. 10 is a diagram showing operation of the request filter table according to the first embodiment of the present invention;

FIG. 11 is a diagram showing an example of a program for use in explaining operation of the determination unit and the owner decision unit according to the present invention;

FIG. 12 is a diagram showing a state of the multiprocessor system for use in explaining operation of the determination unit and the owner decision unit according to the present invention;

FIG. 13 is a diagram showing a state of tables included in the determination unit and the owner decision unit according to the present invention;

FIG. 14 is a diagram showing a state of the tables included in the determination unit and the owner decision unit according to the present invention;

FIG. 15 is a diagram showing a structure of a determination unit according to a second embodiment of the present invention;

FIG. 16 is a diagram showing a structure of an owner decision unit according to a third embodiment of the present invention;

FIG. 17 is a diagram showing a structure of an owner decision unit according to a further embodiment of the present invention;

FIG. 18 is a diagram showing a structure of a conventional consistency control device;

FIG. 19 is a diagram showing operation of the conventional consistency control device;

FIG. 20 is a diagram showing operation of the conventional consistency control device;

FIG. 21 is a diagram for use in explaining operation of the conventional consistency control device;

FIG. 22 is a diagram for use in explaining operation of the conventional consistency control device;

FIG. 23 is a diagram showing a structure of a request unit according to a conventional technique and the present invention;

FIG. 24 is a diagram showing operation of the conventional consistency control device;

FIG. 25 is a diagram showing operation of the conventional consistency control device;

FIG. 26 is a diagram showing a structure of a conventional determination unit; and

FIG. 27 is a diagram showing a structure of a conventional owner decision unit.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

Next, preferred embodiments of the present invention will be described in detail with reference to the drawings.

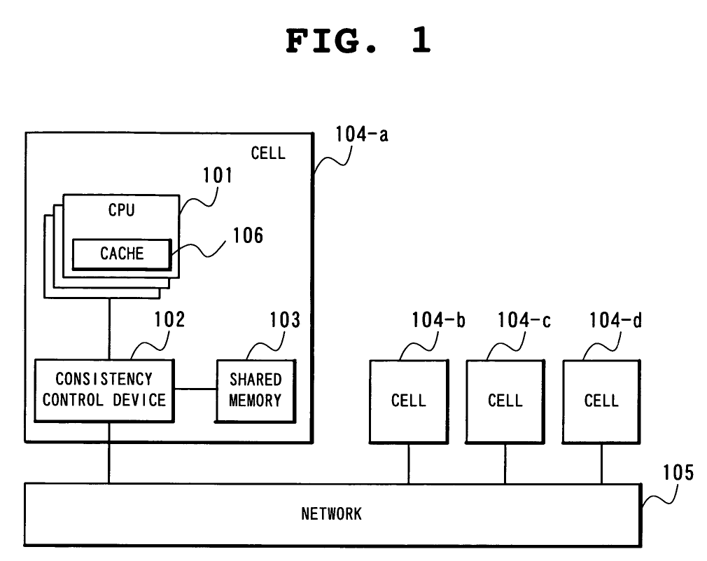

Structure of a multiprocessor system according to a first embodiment of the present invention is the same as that shown in FIG. 1, in which a plurality of cells 104 (104-a to 104-d) including the plurality of CPUs 101 , the consistency control device 102 and the shared memory 103 are connected through the network 105.

Each CPU 101 has the cache 106 which temporarily holds data of the shared memory 103 to realize speed-up of data access.

Here, the network 105 has at least one channel which needs to ensure only an order of messages whose pairs of a transmission source cell 104 and a transmission destination cell 104 coincide with each other. As the network 105, also applicable is a network in which an order of all messages on a bus or the like is guaranteed.

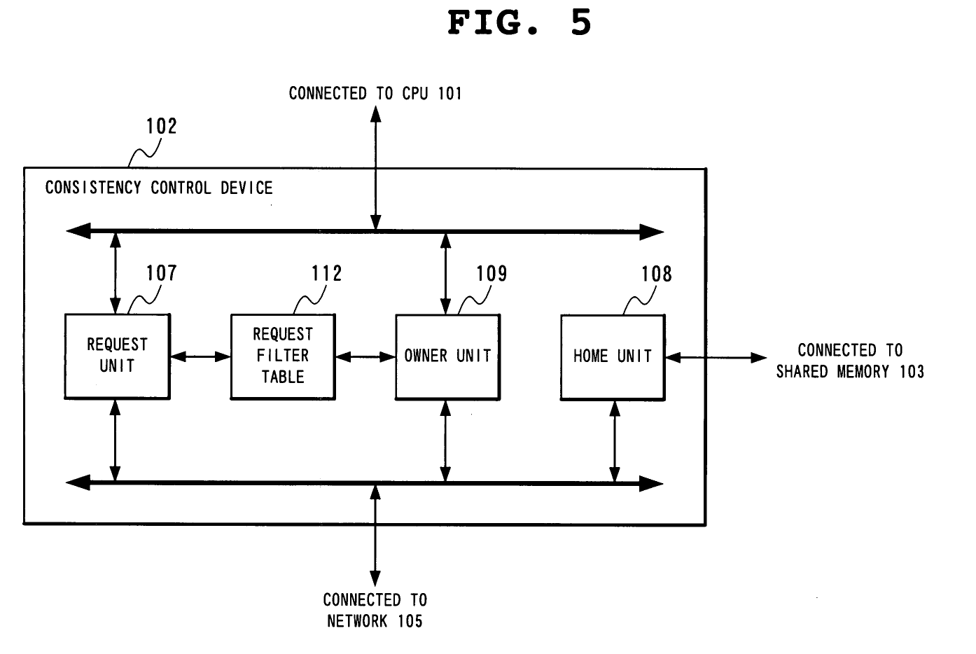

Structure of the consistency control device 102. according to the first embodiment is shown in FIG. 5. The consistency control device 102 includes the request unit 107, the home unit 108, the owner unit 109 and a request filter table 112.

Consistency control of data is realized by sending and receiving a request and an acknowledgement message by the plurality of cells 104 (104-a to 104-d) to/from the request unit 107, the home unit 108 and the owner unit 109.

The request filter table 112 is used for enabling the owner unit 109 to conduct processing of a request message received from the request unit 107 without making an inquiry to the CPU 101.

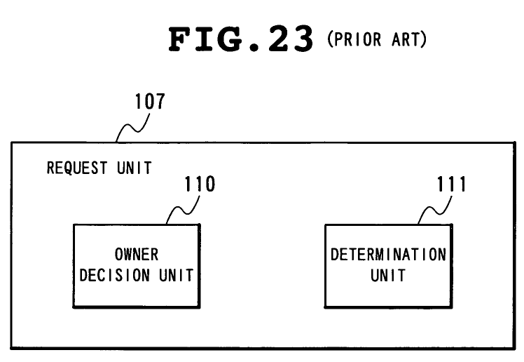

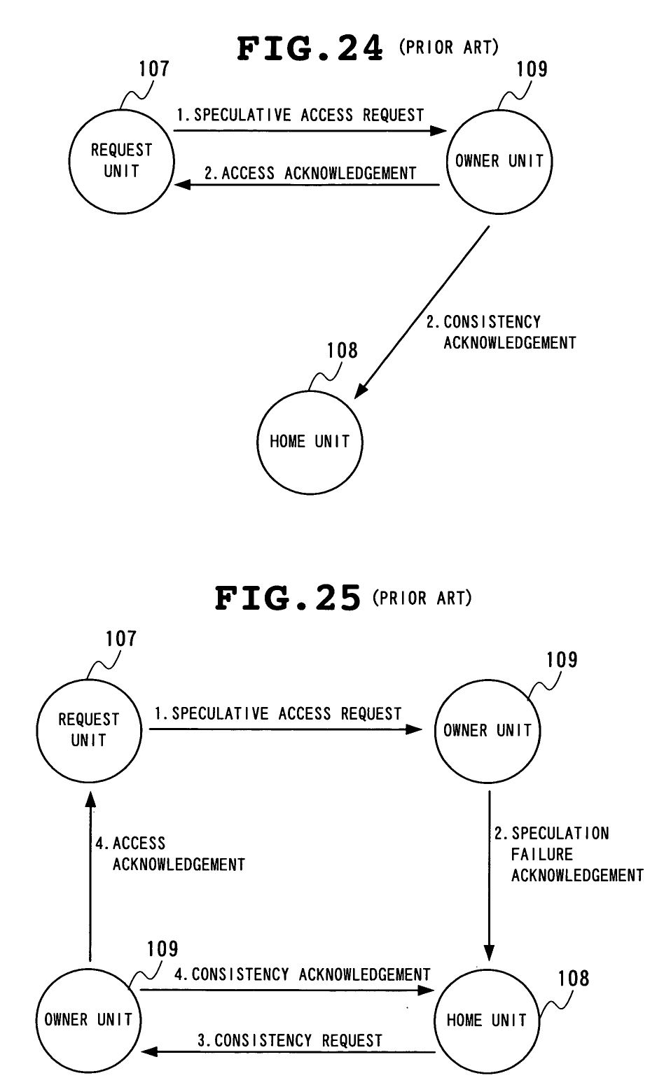

Structure of the request unit 107 is as illustrated in FIG. 23 which has been described in Related Art. The request unit 107 includes the owner decision unit 110 and the determination unit 111. With an access request from the CPU 101 as an input, the owner decision unit 110 predicts which of the cells 104 (cells 104-a to 104-d) holds latest data (cell having latest data) and outputs the prediction result.

With an access request from the CPU 101 as an input, the determination unit 111 determines whether processing based on the prediction by the owner decision unit 110 should be conducted or not and outputs the determination result.

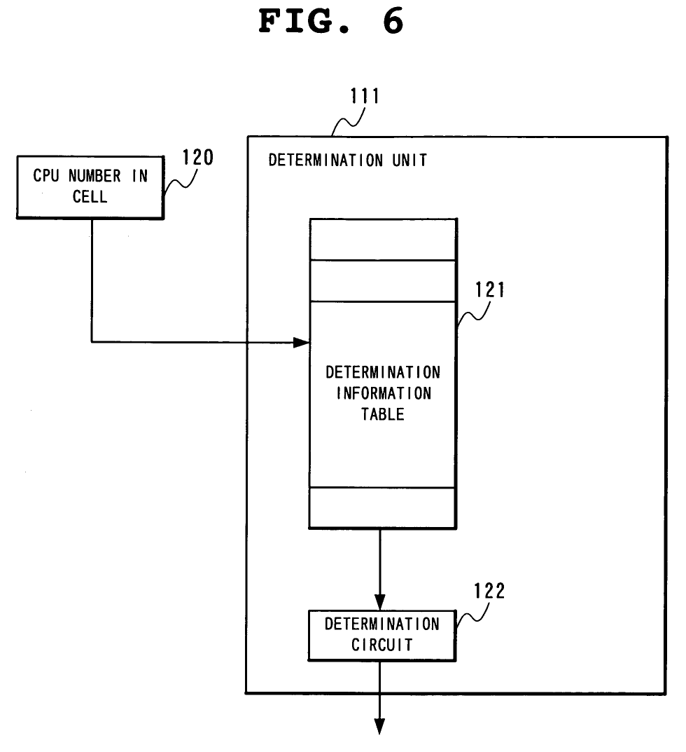

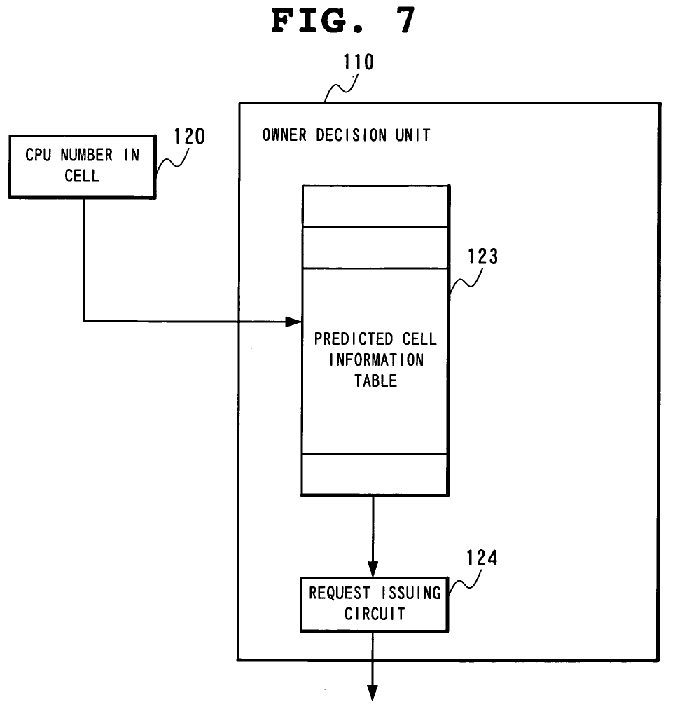

FIGS. 6 and 7 are diagrams showing structures of the owner decision unit 110 and the determination unit 111 according to the present embodiment.

The determination unit 111 includes a determination information table 121 using a CPU number 120 in a cell which identifies the CPU 101 existing in the cell (cells 104-a to 104-d) as a key and a determination circuit 122.

The owner decision unit 110 similarly includes a predicted cell information table 123 using the CPU number 120 in a cell as a key and a request issuing circuit 124.

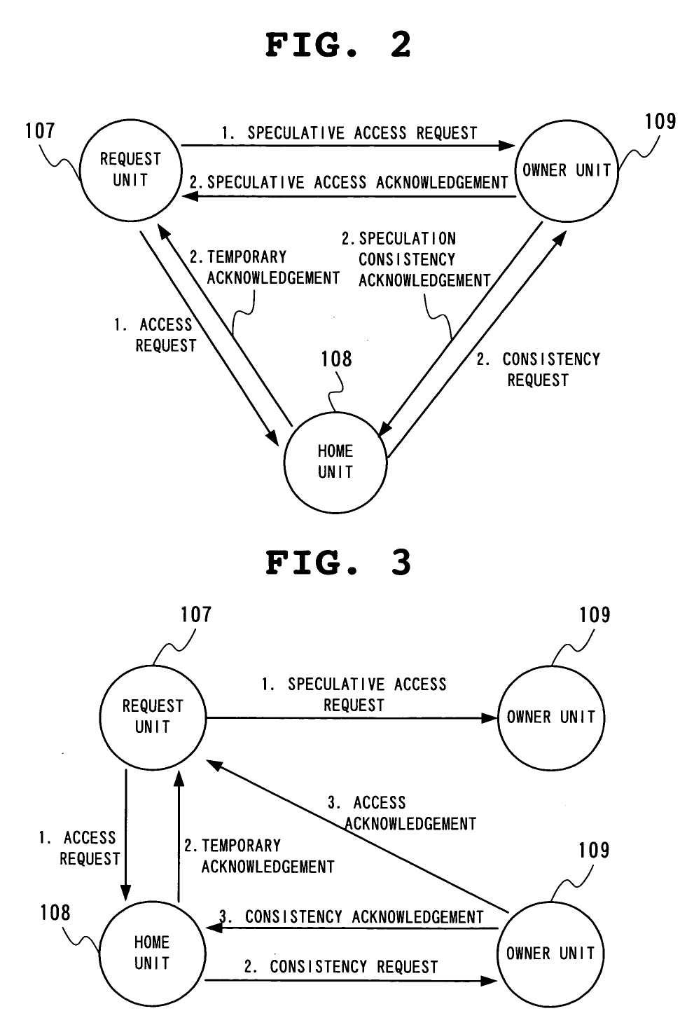

Description will be made of operation of the request unit 107, the home unit 108 and the owner unit 109 of the multiprocessor system according to the first embodiment of the present invention with reference to FIGS. 2, 3 and 4.

FIG. 2 shows operation conducted when a predicted cell 104 holds data. Description will be here made, for example, of a case where the cell 104-a issues an access request to the cell 104-c which holds the data in the shared memory 103, and a speculative access request to the predicted cell 104-b.

The request unit 107 of the request cell 104-a issues an access request to the home unit 108 of the home cell 104-c and issues a speculative access request to the owner unit 109 of the owner cell 104-b predicted by the owner decision unit 110.

Upon receiving the speculative access request, the owner unit 109 of the predicated owner cell 104-b reads data from the cache 106 to give a speculative access acknowledgement to the request unit 107 of the cell 104-a and a speculation consistency acknowledgement to the home unit 108 of the home cell 104-c.

The home unit 108 of the cell 104-c having received the access request issues a temporary acknowledgement to the request unit 107 of the request cell 104-a and a consistency request to the owner unit 109 of the owner cell 104-b. The request unit 107 of the cell 104-a transfers data to the CPU 101 in response to both of the temporary acknowledgement and the speculative access acknowledgement.

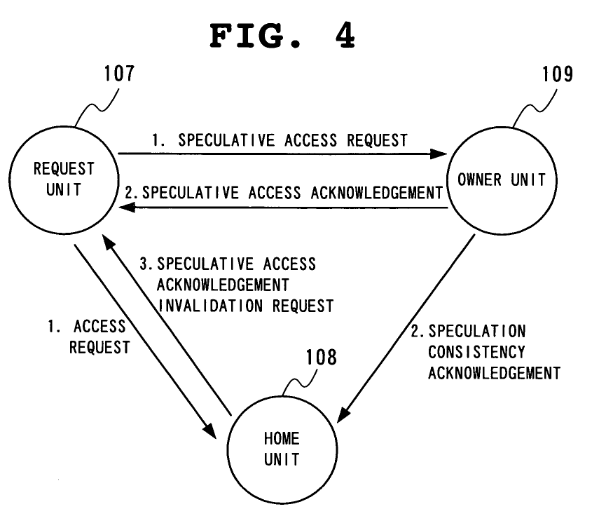

FIG. 3 shows operation conducted when a predicted owner cell 104 does not hold data.

The request unit 107 of the request cell 104-a issues an access request to the home unit 108 of the home cell 104-c and a speculative access request to the owner unit 109 of the owner cell 104-b predicated by the owner decision unit 110.

While the owner unit 109 of the predicted owner cell 104-b receives the speculative access request, it abandons the speculative access request because of not holding the data. Upon receiving the access request, the home unit 108 of the home cell 104-c issues a consistency request to the owner unit 109 of the cell 104 (e.g. cell 104-d) which holds data and a temporary acknowledgement to the request unit 107 of the request cell 104-a.

The owner unit 109 of the cell 104-d having received the consistency request reads data from the cache 106 to give an access acknowledgement to the request unit 107 of the request cell 104-a and a consistency acknowledgement to the home unit 108 of the home cell 104-c. The request unit 107 of the request cell 104-a transfers the data to the CPU 101 in response to the access acknowledgement.

FIG. 4 shows operation conducted when the home unit 108 of the home cell 104-c is yet to receive an access request from the request unit 107 of the request cell 104-a at a time when receiving a speculation consistency acknowledgement from the owner unit 109 of the predicted owner cell 104-b in the case illustrated in FIG. 2.

The home unit 108 of the cell 104-c issues a speculative access acknowledgement invalidation request to the request unit 107 of the request cell 104-a in response to the speculation consistency acknowledgement.

The request unit 107 of the request cell 104-a having received the speculative access acknowledgement invalidation request abandons a speculative access acknowledgement which is to receive or received from the owner unit 109 of the owner cell 104-b. As a result, data consistency can be maintained even when accesses from the plurality of the cells 104 compete.

In the above-described system according to the present embodiment, the owner unit 109 of a predicted owner cell (the cell 104-b in the above-described example) needs to receive both a speculative access request from the request unit 107 and a consistency request from the home unit 108 and process them.

FIGS. 8, 9 and 10 are diagrams for use in explaining operation by the request filter table 112 provided for efficiently conducting the above-described processing at the owner unit 109. The operation will be sequentially described in the following.

Upon receiving a speculative access request (A) which designates an address A, the owner unit 109 checks the request filter table 112. As shown in FIG. 8, when no entry coinciding with the address exists, make an inquiry to the CPU 101 to conduct processing according to a response. Assume here that data of the address A is invalidated by the speculative access request.

When the address A is invalidated, the address A is registered at the request filter table 112 as illustrated in FIG. 9. When there remains no free entry at the time of address registration to make rewriting necessary, a certain entry will be selected and the address A will be overwritten in the entry. In relation to an address registered before the overwriting, neither inquiries to the CPU 101 nor message transfer to the home unit 108 will be made.

Next, when receiving a consistency request of the address A, the owner unit 109 checks the request filter table 112. As shown in FIG. 9, because there exists an entry coinciding with the relevant address, conduct processing without making inquiries to the CPU 101 assuming that no data exists in the cache 106.

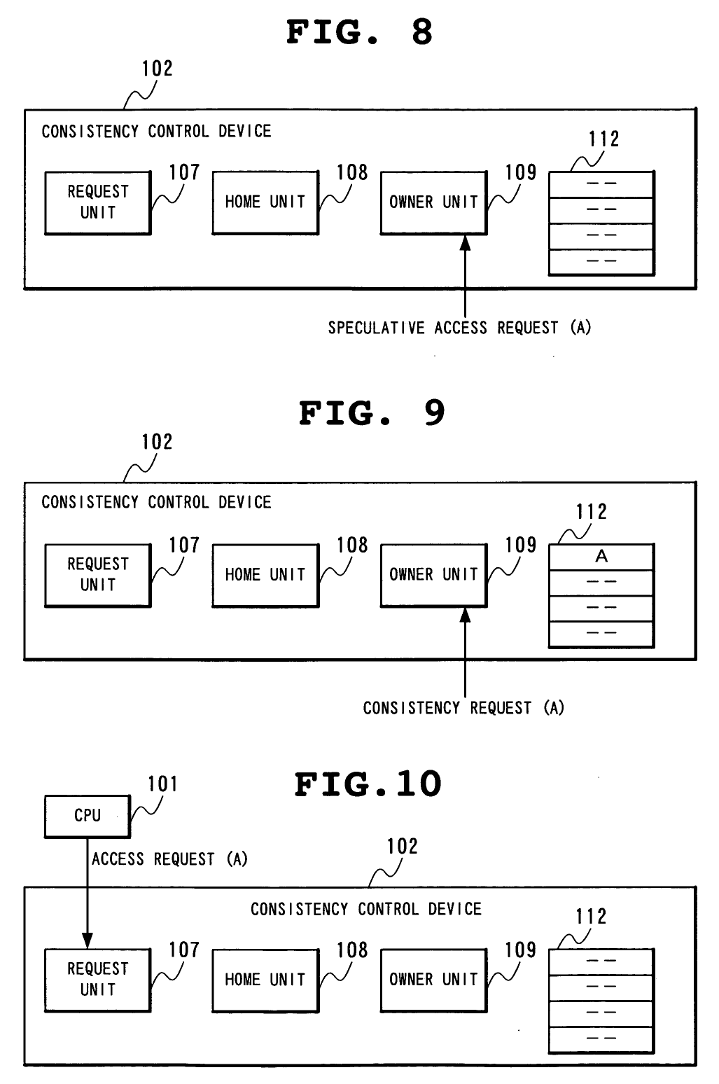

Next, when receiving an access request of the address A from the CPU 101, the request unit 107 checks the request filter table 112. As shown in FIG. 9, because there exists an entry coinciding with the relevant address, invalidate the data of the entry as shown in FIG. 10.

Here, invalidation of an entry in the request filter table 112 may be conducted at, in addition to the time when the request unit 107 receives an access request, the time when the owner unit 109 checks the request filter table 112 to find that there exists an entry having a coincident address.

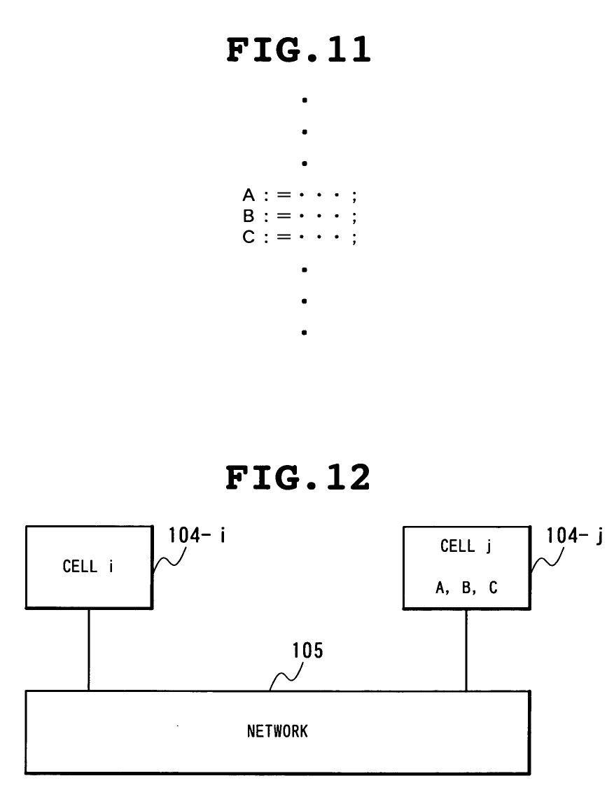

Lastly, operation of the determination unit 111 and the owner decision unit 110 will be described. Shown in FIG. 11 is a program in which write to the address A is made at a certain part of the program and subsequently write to an address B and lastly write to an address C are made.

First, as illustrated in FIG. 12, assume that the program shown in FIG. 11 is executed at a cell 104-j and that data of the addresses A, B and C is held in the cache 106 of the cell 104-j (in the structure shown in FIG. 1, the cells 104-i and 104-j are any of the cells 104-a, 104-b, 104-c and 104-d). Next, assume that the same program is executed at the CPU 101 of the cell 104-i.

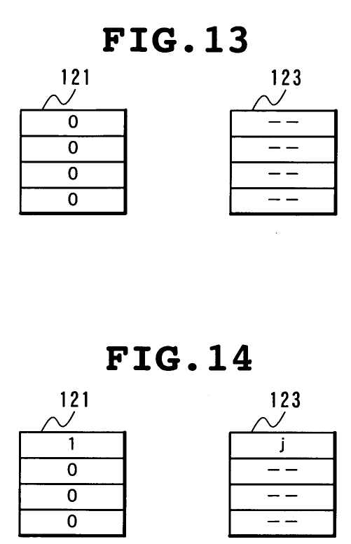

FIGS. 13 and 14 show state transition of the determination information table 121 and the predicted cell information table 123 in a case where with four CPUs 101 (No. 0 to No. 3) existing in the cell 104, the above-described program is executed at the No. 0 CPU 101.

The tables 121 and 123 are each formed of four entries. Assume that stored in the determination information table 121 is “0” or “1”, with “0” indicating that no prediction operation will be made and “1” indicating that prediction operation will be made. Each entry in the determination information table 121 corresponds to each number of the CPU 101 in a cell. Also assume that a number for identifying the cell 104 is stored in the predicted cell information table 123.

Hereinafter, operation of the determination unit 111 and the owner decision unit 110 at the cell 104-i in this case will be sequentially described.

At an initial state, stored in the determination information table 121 is all “0” (value indicating that no prediction operation will be made). Assume that the number 0 CPU 101 executes the program shown in FIG. 11 to conduct write to the address A.

As a result of the write, an access request is issued to the request unit 107 of the cell 104-i. In response to the access request of the address A from the number 0 CPU 101, the request unit 107 of the cell 104-i outputs “0” as the CPU number 120 in the cell to the determination unit 111.

Upon receiving “0” as the CPU number 120 in the cell, the determination unit 111 reads the value “0” of the number 0 entry corresponding to the number 0 CPU in the determination information table 121 (see FIG. 13). The read contents “0” will be transferred to the determination circuit 122, in which the value is discriminated to transfer a determination result that no prediction operation will be made to the request unit 107. The request unit 107 of the cell 104-i receives data from the cell 104-j by conducting processing of the access request in the same manner as in the conventional technique disclosed in Literature 1.

Upon receiving the data, the request unit 107 of the cell 104-i updates the number 0 entry of the determination information table 121 to “1” (contents indicating that prediction operation will be made) and the contents of the number 0 entry of the predicted cell information table 123 to j (see FIG. 14) because the access is the case of cache-to-cache transfer.

Next, write to the address B is conducted. As a result of the write, an access request is issued to the request unit 107.

The request unit 107 of the cell 104-i outputs “0” as the CPU number 120 in the cell to the determination unit 111 in response to the access request of the address B from the number 0 CPU 101. The determination unit 111 reads the contents “1” of the number 0 entry in the determination information table 121 upon receiving 0 of the CPU number 120 in the cell (see FIG. 14).

The value “1” is transferred to the determination circuit 122 and discriminated, so that a determination result that prediction operation will be conducted will be transferred to the request unit 107. The request unit 107 then outputs the value “0” of the CPU number 120 in the cell to the owner decision unit 110.

Upon receiving the value “0” of the CPU number 120 in the cell, the owner decision unit 110 reads the contents “j” of the number 0 entry in the predicted cell information table 123 (see FIG. 14). The information “j” indicative of the number of a predicted cell will be transferred to the request issuing circuit 124, so that the request issuing circuit 124 informs the request unit 107 to the effect that a speculative access request will be issued to the cell 104-j.

Upon receiving the notification, the request unit 107 conducts the operation shown in FIGS. 2, 3 and 4 to issue a speculative access request to the owner unit 109 of the cell 104-j notified by the owner decision unit 110. The owner unit 109 of the cell 104-j reads data form the cache 106 in response to the speculative access request and transfers the data by the speculative access acknowledgement to the request unit 107 of the requesting source cell 104-i.

Upon receiving the data, the request unit 107 updates the contents of the number 0 entry in the determination information table 121 to “1” and the contents of the number 0 entry of the predicted cell information table 123 to “j” because the access is the case of cache-to-cache transfer.

Next, write to the address C is conducted. The access request by this write will be subjected to the same processing as the above-described processing of the address B.

Thus, while no prediction operation will be conducted with respect to the initial address A, prediction operation will be conducted with respect to the subsequent addresses B and C and the predicted contents (predicted cell) will be fulfilled. On the other hand, according to a conventional system using a table with keys generated by a PC (program counter) and an address, it is highly possible in the above-described case that different keys are generated for the addresses A, B and C, respectively, resulting in that no prediction operation might be conducted in some cases.

According to the above-described first embodiment, predicting a cell having data to issue an access request and a speculative access request to the home unit and the owner unit leads to improvement of memory access performance when the prediction is fulfilled and to realization of the same latency as conventional one even when the prediction fails.

The speculative access request may be issued to a plurality of owner units 109. The request unit 107 may include a plurality of determination units 111 and owner decision units 110.

Although shown as the structure of the above-described embodiment is a case where the request unit 107 includes the determination unit 111 and the owner decision unit 110, the CPU 101 may include the determination unit 111 and the owner decision unit 110 to issue an access request and a speculative access request to the request unit 107, so that the request unit responsively issues an access request to the home unit 108 and a speculative access request to the owner unit 109 of a designated cell. This is equivalent to assigning a part of the function of the consistency control device 102 to the CPU 101, and the function of each cell in the multiprocessor system itself has no change.

In the case of FIG. 3, the owner unit 109 having received the speculative access request may give a speculative access failure acknowledgement to the request unit 107.

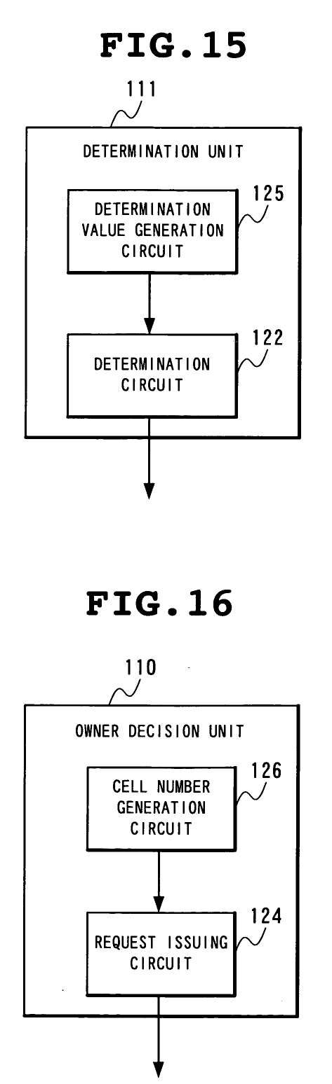

As a second embodiment, the determination unit 111, as shown in FIG. 15, may include a determination value generation circuit 125 which outputs the value 0 or “1” at random or with fixed regularities to determine at random or regularly whether prediction operation should be conducted or not.

Similarly, as a third embodiment, the owner decision unit 110, as shown in FIG. 16, may include a cell number generation circuit 126 which outputs a cell number at random or with fixed regularities to determine a cell as an owner at random or with regularities.

The cell number generation circuit 126 may output a cell number at random, or with numbers of specific cells combined in advance, it may be determined before hand which cell number is to be output in response to a request from a certain cell, or the circuit may output cell numbers in order with fixed regularities.

Structuring the determination unit 111 and the owner decision unit 110 as illustrated in FIGS. 15 and 16 eliminates the need of such determination information table 121 and predicted cell information table 123 using the CPU number 120 in a cell as a key as described in the above embodiment, thereby reducing the amount of hardware as much as possible.

In a case where the number of cells forming the multiprocessor system is small, in particular, even such a structure having the determination value generation circuit 125 and the cell number generation circuit 126 as described above attains satisfactory improvement of memory access performance.

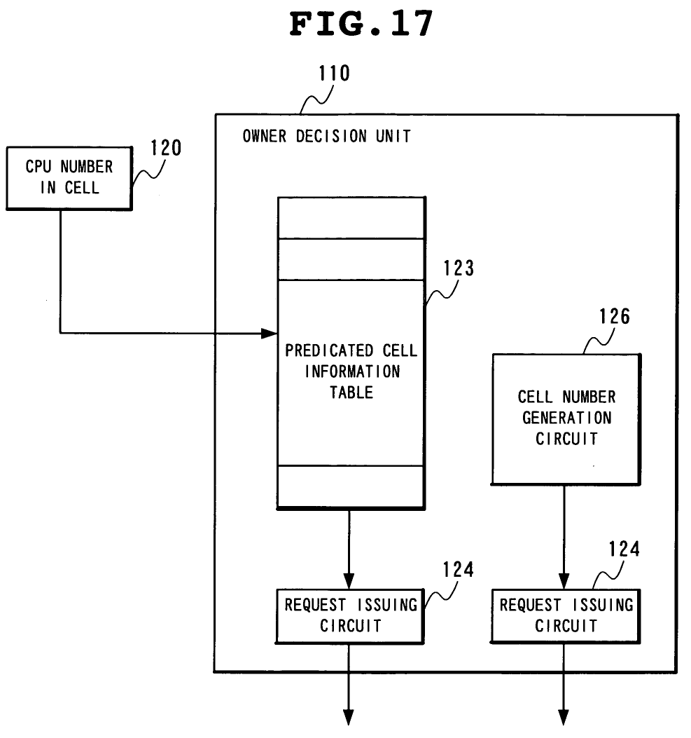

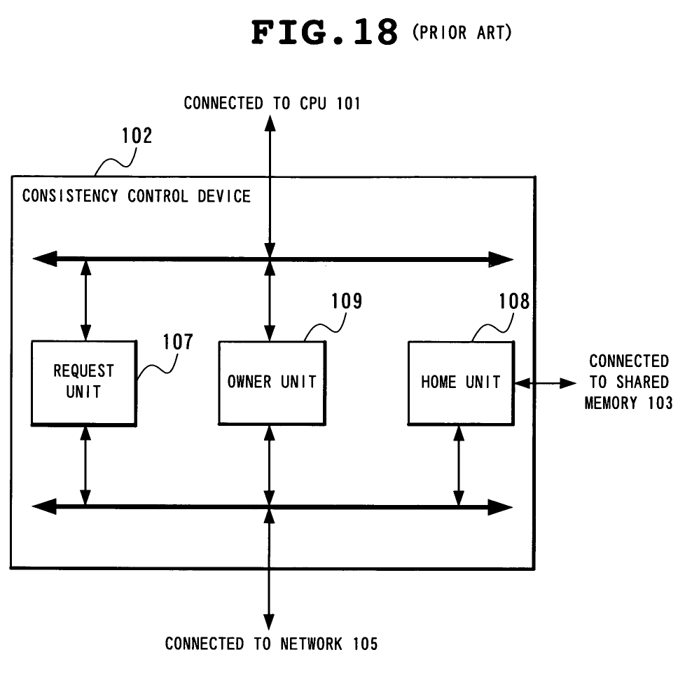

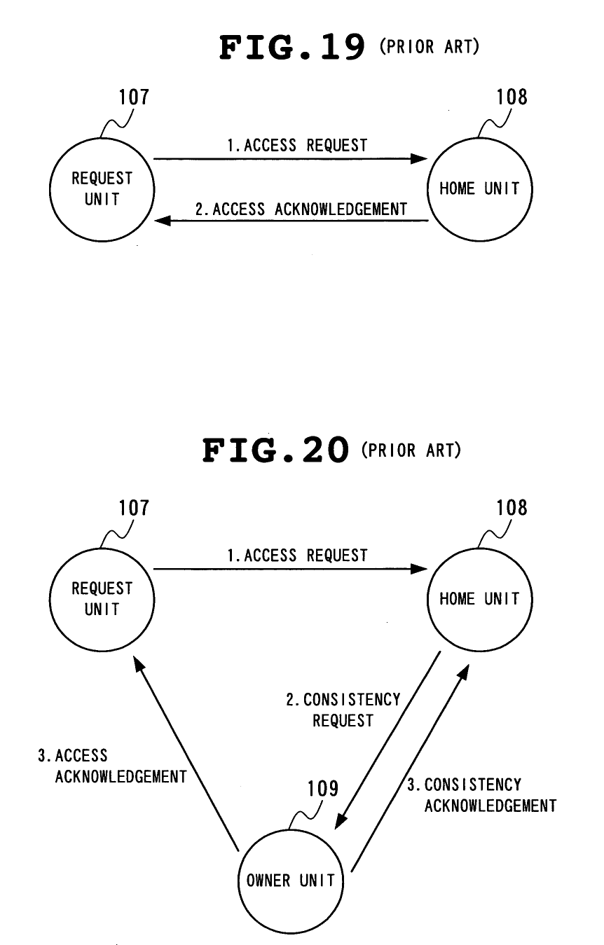

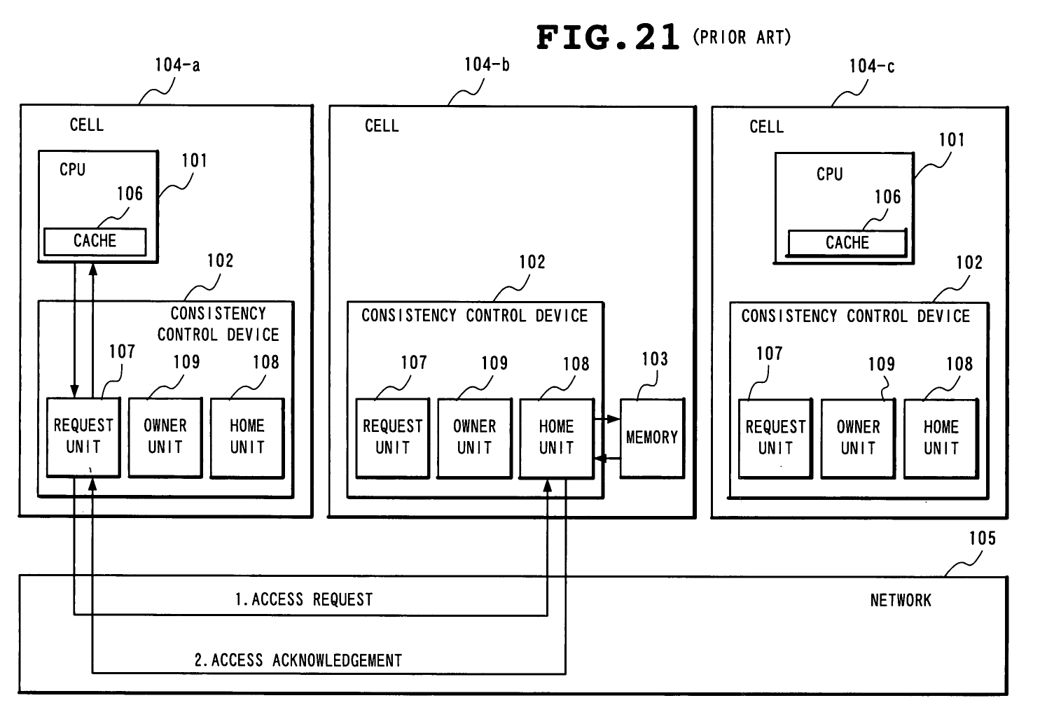

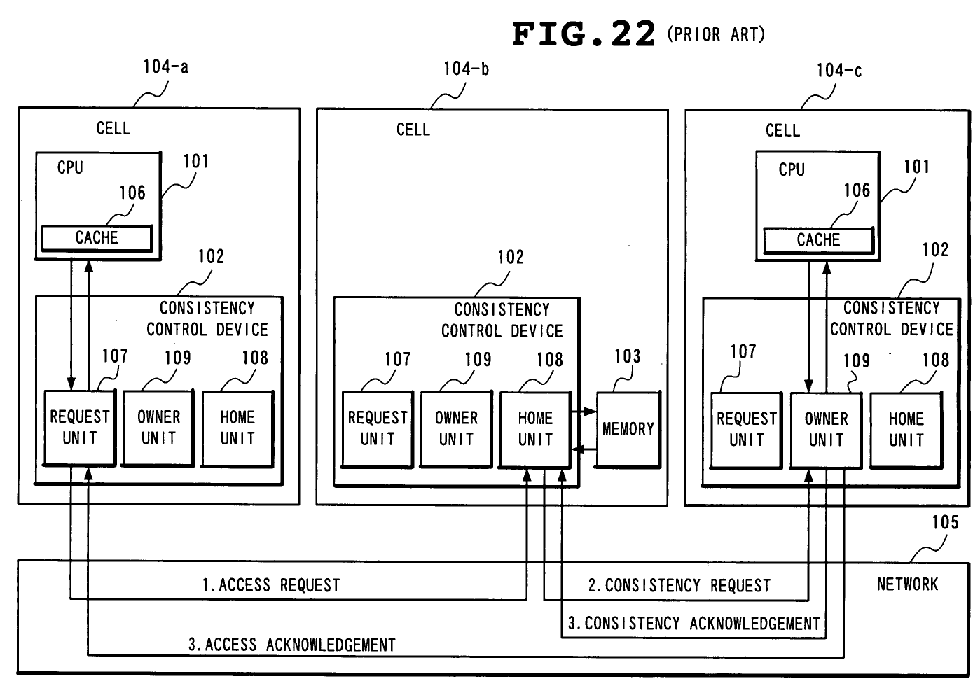

As shown in FIG. 17, it is also possible to make the owner decision unit 110 shown in the above-described first embodiment include the cell number generation circuit 126 shown in FIG. 16 as the third embodiment. In this case, the owner decision unit 110 outputs a plurality of cell numbers to issue a speculative access request to a plurality of the owner units 109.

As to the determination unit 111, the structure according to the first embodiment and that according to the second embodiment shown in FIG. 15 can be combined.

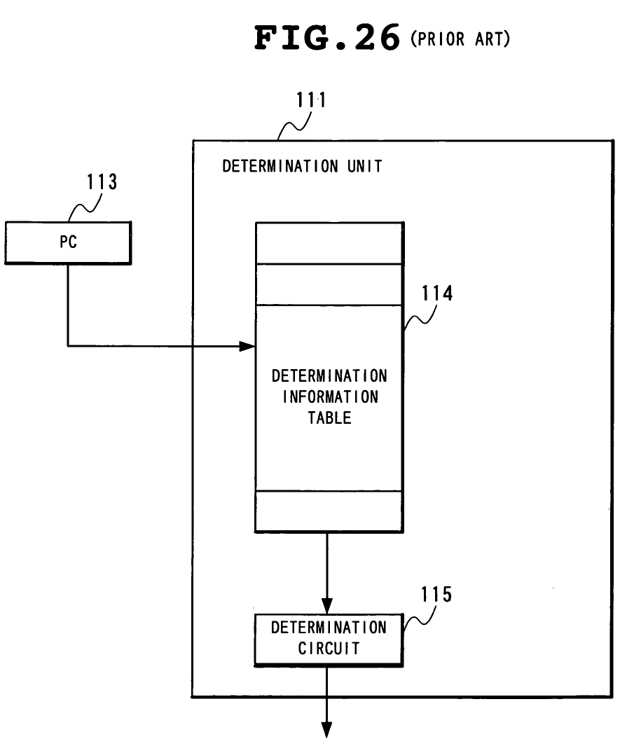

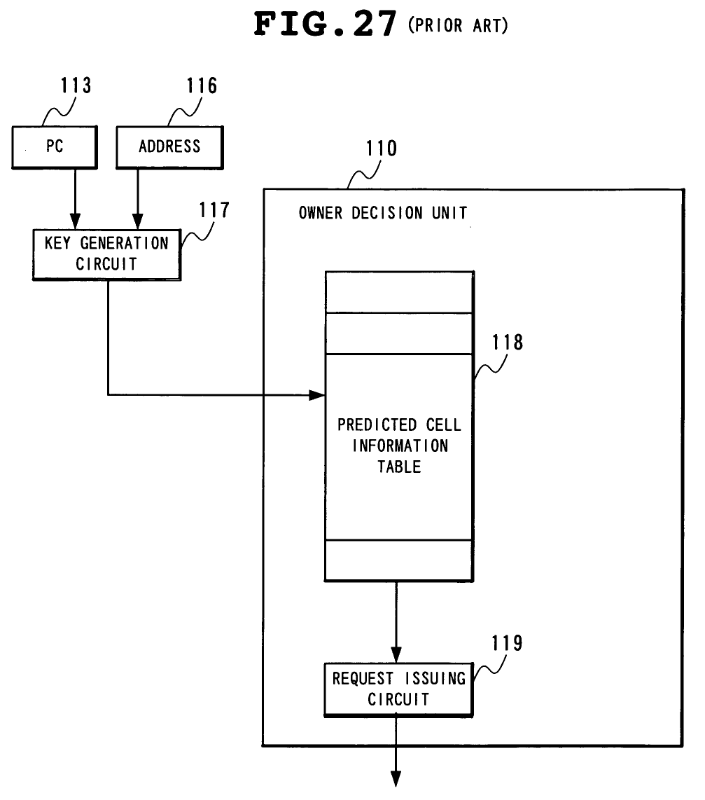

Furthermore, as a further embodiment of the determination unit 111 and the owner decision unit 110, the conventional structure shown in FIGS. 26 and 27 and the structure of the present embodiment can be combined. Such combination enables selection of more effective combination according to the contents of the multiprocessor system.

Although the present invention has been described with respect to the preferred embodiments in the foregoing, the present invention is not necessarily limited to the above-described embodiments. It will be understood that various modifications are possible without departing from the gist of the present invention.

Each function of the consistency control device 102 can be realized by providing, for example, a computer device, with the above-described functions. More specifically, each function may be realized by executing, by the CPU 101, a program which attains, as software, the function of the consistency control device.

For realizing the function of the consistency control device 102 by software, load and execute a program which realizes the function of each consistency control device on a program-controllable computer processing device (CPU). The program is stored in a magnetic disk, a semiconductor memory or other recording medium and loaded from the recording medium into the computer processing device to control operation of the CPU, thereby achieving a function peculiar to each device.

The first effect of the foregoing described present invention is enabling memory access performance to be improved in a case where cache-to-cache transfer is conducted.

The reason is that predicting a cell having data to issue an access request and a speculative access request to the home unit and the owner unit enables improvement in memory access performance when the prediction is fulfilled and enables the same latency to be realized as that of a conventional case even when the prediction fails.

The second effect of the present invention is enabling reduction of the amount of hardware necessary for the request unit for the purpose of consistency control.

The reason is that the determination information table held in the determination unit is formed as a table using a CPU number in a cell as a key. In addition, the owner cell information table held in the owner decision unit is also formed as a table using a CPU number in a cell as a key.

Furthermore, the amount of hardware necessary for the request unit for the purpose of consistency control can be further reduced by structuring the system such that the determination unit holds the determination value generation circuit in place of the determination information table to eliminate the need of a table and such that the owner decision unit holds the cell number generation circuit in place of the owner cell information table.

The present invention is applicable not only to a hardware-controlled shared memory type multiprocessor system but also to a software-controlled shared memory type multiprocessor system. It is also applicable to consistency control of a disk cache of a large-scale disk array device.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

1. A multiprocessor system with cells having a plurality of CPUs sharing a memory connected through a network, comprising:
a request consistency control device configured to generate both an access request and a speculative access request simultaneously;
a home consistency control device configured to receive said access request; and
an owner consistency control device configured to receive said speculative access request,
wherein said request consistency control device includes
an owner decision unit which predicts which cell holding requested data, and
a determination unit which determines whether processing based on prediction is to be conducted or not.

2. The multiprocessor system as set forth in claim 1, wherein
said owner consistency control device has a function of issuing a speculative access acknowledgement in response to a speculative access request, and
said request consistency control device has a function of receiving a speculative access acknowledgement.

3. The multiprocessor system as set forth in claim 1, wherein
said home consistency control device has a function of issuing a consistency request in response to an access request, and
said owner consistency control device has a function of receiving a consistency request.

4. The multiprocessor system as set forth in claim 1, wherein
said home consistency control device has a function of issuing a temporary acknowledgement in response to an access request, and
said request consistency control device further has a function of receiving a temporary acknowledgement from the home unit of each cell.

5. The multiprocessor system as set forth in claim 1, wherein
said owner consistency control device further has a function of issuing a speculation consistency acknowledgement in response to a speculative access request, and
said home consistency control device further has a function of receiving a speculation consistency acknowledgement.

6. The multiprocessor system as set forth in claim 1, wherein
said owner consistency control device further has a function of issuing a speculation consistency acknowledgement in response to a speculative access request,
said home consistency control device further has a function of receiving a speculation consistency acknowledgement and when said home consistency control device is yet to receive a relevant access request at a time point when receiving said speculation consistency acknowledgement, issuing a speculative access acknowledgement invalidation request, and
said request consistency control device further has a function of receiving a speculative access acknowledgement invalidation request.

7. The multiprocessor system as set forth in claim 1, wherein
said owner consistency control device further has a function of issuing a speculative access acknowledgement and a speculation consistency acknowledgement in response to a speculative access request,
said home consistency control device further has a function of receiving a speculation consistency acknowledgement and a function of, when said home consistency control device is yet to receive a relevant access request at a time point when receiving said speculation consistency acknowledgement, issuing a speculative access acknowledgement invalidation request, and
said request consistency control device further has a function of receiving a speculative access acknowledgement, and
a function of receiving a speculative access acknowledgement invalidation request and a function of invalidating a relevant speculative access acknowledgement in response to a speculative access acknowledgement invalidation request.

8. The multiprocessor system as set forth in claim 1, wherein
said home consistency control device has a function of issuing a consistency request in response to an access request,
said owner consistency control device has a function of receiving a consistency request, and
said request consistency control device further includes a request filter table, said consistency control device registering an address of a request received lately by said owner unit and not existing in a cache at said request filter table and when said owner unit receives a request, if there exists in said request filter table an entry coinciding with the request, processing a request message without making an inquiry to the CPU.

9. The multiprocessor system as set forth in claim 1, wherein
said determination unit includes a table with a CPU number in a cell as a key, said determination unit determining whether prediction operation is to be conducted according to a value of a CPU number stored in said table.

10. The multiprocessor system as set forth in claim 1, wherein
said determination unit includes a determination value generation circuit which generates a value indicative of existence/non-existence of prediction operation by random numbers or with fixed regularities, said determination unit determining whether prediction operation is to be conducted according to a value output by the determination value generation circuit.

11. The multiprocessor system as set forth in claim 1, wherein
said owner decision unit includes a table with a CPU number in a cell as a key, said owner decision unit deciding to which cell a speculative access request is to be issued according to a value of a CPU number stored in said table.

12. The multiprocessor system as set forth in claim 1, wherein
said owner decision unit includes a cell number generation circuit which generates a value indicative of a number of a cell by random numbers or with fixed regularities, said owner decision unit deciding to which cell a speculative access request is to be issued according to a value output by the cell number generation circuit.

13. The multiprocessor system as set forth in claim 1, wherein
said owner decision unit includes a cell number generation circuit which generates a value indicative of a number of a cell by random numbers or with fixed regularities, said owner decision unit deciding to which cell a speculative access request is to be issued according to a value output by the cell number generation circuit, and
said network has at least one channel, said channel having a structure which ensures, with respect to messages flowing through the channel, only an order of arrival of messages whose pairs of a transmission source cell and a transmission destination cell are the same and not an order of arrival of messages whose pairs are different.

14. A consistency control method in a multiprocessor system with cells having a plurality of CPUs sharing a memory connected through a network, comprising the steps of;
a request consistency control device generating both an access request and a speculative access request simultaneously;
a home consistency control device receiving said access request; and
a owner consistency control device receiving said speculative access request,
wherein said request consistency control device predicts which cell holding requested data and determines whether processing based on prediction is to be conducted or not.

15. The consistency control method in a multiprocessor system as set forth in claim 14, wherein
said owner consistency control device issuing a speculative access acknowledgement in response to a speculative access request, and
said request consistency control device receiving a speculative access acknowledgement.

16. The consistency control method in a multiprocessor system as set forth in claim 14, wherein
said home consistency control device issuing a consistency request in response to an access request, and
said owner consistency control device receiving a consistency request.

17. The consistency control method in a multiprocessor system as set forth in claim 14, wherein
said home consistency control device issuing a temporary acknowledgement in response to an access request, and
said request consistency control device receiving a temporary acknowledgement.

18. The consistency control method in a multiprocessor system as set forth in claim 14, wherein
said owner consistency control device issuing a speculation consistency acknowledgement in response to a speculative access request, and
said home consistency control device receiving a speculation consistency acknowledgement.

19. The consistency control method in a multiprocessor system as set forth in claim 14, wherein
said owner consistency control device issuing a speculation consistency acknowledgement in response to a speculative access request,
said home consistency control device receiving a speculation consistency acknowledgement and when a relevant access request is yet to be received at a time point when receiving said speculation consistency acknowledgement, and issuing a speculative access acknowledgement invalidation request, and
said request consistency control device receiving a speculative access acknowledgement invalidation request.

20. The consistency control method in a multiprocessor system as set forth in claim 14, wherein
said owner consistency control device issuing a speculative access acknowledgement and a speculation consistency acknowledgement in response to a speculative access request,
said home consistency control device receiving a speculation consistency acknowledgement and when a relevant access request is yet to be received at a time point when receiving said speculation consistency acknowledgement, and issuing a speculative access acknowledgement invalidation request, and
said request consistency control device receiving a speculative access acknowledgement, and
receiving a speculative access acknowledgement invalidation request and a function of invalidating a relevant speculative access acknowledgement in response to a speculative access acknowledgement invalidation request.

21. The consistency control method in a multiprocessor system as set forth in claim 14, wherein
said home consistency control device issuing a consistency request in response to an access request and receiving a consistency request, and
said request consistency control device registering an address of a request received lately and not existing in a cache at a request filter table and when receiving a request, if there exists an entry coinciding with the request in said request filter table, processing a request message without making an inquiry to the CPU.

22. The consistency control method in a multiprocessor system as set forth in claim 14, wherein
said request consistency control device includes a table with a CPU number in a cell as a key and includes the step of determining whether prediction operation is to be conducted according to a value of a CPU number stored in said table.

23. The consistency control method in a multiprocessor system as set forth in claim 14, wherein
said request consistency control device generating a value indicative of existence/non-existence of prediction operation by random numbers or with fixed regularities, and
determining whether prediction operation is to be conducted according to a generated value.

24. The consistency control method in a multiprocessor system as set forth in claim 14, wherein
said request consistency control device includes a table with a CPU number in a cell as a key and includes the step of deciding to which cell a speculative access request is to be issued according to a value of a CPU number stored in said table.

25. The consistency control method in a multiprocessor system as set forth in claim 14, wherein
said request consistency control device generating a value indicative of a number of a cell by random numbers or with fixed regularities, and
deciding to which cell a speculative access request is to be issued according to a generated value.

26. A consistency control device in a multiprocessor system with cells having a plurality of CPUs sharing a memory and a consistency control device connected through a network, comprises:
a request unit which issues an access request and a speculative access request,
a home unit which receives an access request, and an owner unit which receives a speculative access request,
wherein said request unit includes
an owner decision unit which predicts which cell holding requested data, and
a determination unit which determines whether processing based on prediction is to be conducted or not.

27. The consistency control device in a multiprocessor system as set forth in claim 26, wherein
said owner unit issues a speculative access acknowledgement in response to a speculative access request, and
said request unit has a function of receiving a speculative access acknowledgement.

28. The consistency control device in a multiprocessor system as set forth in claim 26, wherein
said home unit has a function of issuing a consistency request in response to an access request, and
said owner unit has a function of receiving a consistency request.

29. The consistency control device in a multiprocessor system as set forth in claim 26, wherein
said home unit further issues a temporary acknowledgement in response to an access request, and
said request unit further has a function of receiving a temporary acknowledgement.

30. The consistency control device in a multiprocessor system as set forth in claim 26, wherein
said owner unit further issues a speculation consistency acknowledgement in response to a speculative access request, and
said home unit further has a function of receiving a speculation consistency acknowledgement.

31. The consistency control device in a multiprocessor system as set forth in claim 26, wherein
said owner unit further has a function of issuing a speculation consistency acknowledgement in response to a speculative access request,
said home unit further has a function of receiving a speculation consistency acknowledgement and a function of, when the home unit is yet to receive a relevant access request at a time point when receiving said speculation consistency acknowledgement, issuing a speculative access acknowledgement invalidation request, and
said request unit further has a function of receiving a speculative access acknowledgement invalidation request.

32. The consistency control device in a multiprocessor system as set forth in claim 26, wherein
said owner unit further has a function of issuing a speculative access acknowledgement and a speculation consistency acknowledgement in response to a speculative access request,
said home unit further has a function of receiving a speculation consistency acknowledgement and a function of, when the home unit is yet to receive a relevant access request at a time point when receiving said speculation consistency acknowledgement, issuing a speculative access acknowledgement invalidation request, and
said request unit further has a function of receiving a speculative access acknowledgement, and
a function of receiving a speculative access acknowledgement invalidation request and a function of invalidating a relevant speculative access acknowledgement in response to a speculative access acknowledgement invalidation request.

33. The consistency control device in a multiprocessor system as set forth in claim 26, wherein
said home unit has a function of issuing a consistency request in response to an access request,
said owner unit has a function of receiving a consistency request, and
said consistency control device includes a request filter table, said consistency control device registering an address of a request received lately by said owner unit and not existing in a cache at said request filter table and when said owner unit receives a request, if there exists in said request filter table an entry coinciding with the request, processing a request message without making an inquiry to the CPU.

34. The consistency control device in a multiprocessor system as set forth in claim 26, wherein
said determination unit includes a table with a CPU number in a cell as a key, said determination unit determining whether prediction operation is to be conducted according to a value of a CPU number stored in said table.

35. The consistency control device in a multiprocessor system as set forth in claim 26, wherein
said determination unit includes a determination value generation circuit which generates a value indicative of existence/non-existence of prediction operation by random numbers or with fixed regularities, said determination unit determining whether prediction operation is to be conducted according to a value output by the determination value generation circuit.

36. The consistency control device in a multiprocessor system as set forth in claim 26, wherein
said owner decision unit includes a table with a CPU number in a cell as a key, said owner decision unit deciding to which cell a speculative access request is to be issued according to a value of a CPU number stored in said table.

37. The consistency control device in a multiprocessor system as set forth in claim 26, wherein
said owner decision unit includes a cell number generation circuit which generates a value indicative of a number of a cell by random numbers or with fixed regularities, said owner decision unit deciding to which cell a speculative access request is to be issued according to a value output by the cell number generation circuit.
